(19) United States
(12) Patent Application Publication
(10) Pub. No.: US 2024/0223459 A1
(43) Pub. Date: Jul. 4, 2024

(54) COMMUNICATION NETWORK MODEL CONSTRUCTION DEVICE, COMMUNICATION NETWORK MODEL CONSTRUCTION METHOD AND PROGRAM

(71) Applicant: Nippon Telegraph and Telephone Corporation, Tokyo (JP)

(72) Inventors: Tomohiro KORIKAWA, Musashino-shi, Tokyo (JP); Masafumi SHIMIZU, Musashino-shi, Tokyo (JP); Naoki TAKAYA, Musashino-shi, Tokyo (JP); Hidenari OWADA, Musashino-shi, Tokyo (JP); Kyota HATTORI, Musashino-shi, Tokyo (JP)

(21) Appl. No.: 18/577,175

(22) PCT Filed: Jul. 19, 2021
(86) PCT No.: PCT/JP2021/027005

§ 371 Date: Jan. 5, 2024

(51) Int. Cl. H04L 41/12; G01S 19/01; H04L 41/0866; H04L 41/14

(52) U.S. Cl. CPC H04L 41/12; H04L 41/0866; H04L 41/145; G01S 19/01

(57) ABSTRACT

Information related to DCs (31a to 31d) is specified from a GPS (35), a camera (36), and a sensor (37) of each of the DCs (31a to 31d), and physical information (D6), which is information indicating addition or deletion of each of actual nodes (32a to 32f) in the DCs, is obtained from image information and detection information of the specified DCs. Logical information (D8), which is information enabling determination of addition or deletion of each of the actual nodes (32a to 32f) in the DCs and peripheral nodes (32e and 32f) connected to the actual nodes, is obtained. Both the physical information (D6) and the logical information (D8) is combined, so that addition or deletion of each of the actual nodes (32a to 32f) in the DCs (31a to 31d) is estimated, and the estimated addition or deletion of each of the actual nodes in the DCs and a change in setting information of another actual node accompanying the addition or deletion of the actual nodes are reflected in node models (21a to 21f) of a communication NW model (21).

### TECHNICAL FIELD

The present invention relates to a communication network model construction device, a communication network model construction method, and a program for estimating a correspondence relationship between actual nodes constituting a communication network and node models on a network model and updating the network model in accordance with addition or deletion of an actual node.

### BACKGROUND ART

An actual communication network is constructed by connecting nodes (also referred to as actual nodes) as communication devices such as a server, a router, and a switch through a wired or wireless network {also referred to as a NW (network)}. Note that the actual communication network is also referred to as the actual NW.

In conventional techniques, a connection (NW topology) between nodes constituting a certain NW is estimated on the basis of setting information or the like that can be acquired from the nodes. As this type of conventional technique, there are techniques described in Non Patent Literatures 1 and 2.

### CITATION LIST

### Non Patent Literature

Non Patent Literature 1: Yuri Breitbart et al., “Topology Discovery in Heterogeneous IP Networks: The Net Inventory System”, IEEE/ACM TRANSACTIONS ON NETWORKING, VOL. 12, NO. 3, JUNE 2004.

Non Patent Literature 2: Suleman Khan et al., “Topology Discovery in Software Defined Networks: Threats, Taxonomy, and State-of-the-Art”, IEEE COMMUNICATIONS SURVEYS & TUTORIALS, VOL. 19, NO. 1, FIRST QUARTER 2017.

### SUMMARY OF INVENTION

### Technical Problem

A conventional communication NW model is mainly configured to include node models connected by a NW in accordance with setting information and connection information of actual nodes. However, the conventional techniques merely perform collection of the setting information of the actual nodes and visualization of the logical connection relationship between the actual nodes, and there is a problem that the node models constituting the NW model do not correspond to the actual nodes of an actual NW on one-to-one basis or the like with the physical arrangement and the like of the actual nodes appropriately reflected. For this reason, for example, for a disaster in a data center in which an actual node is deployed, simulation of the disaster range and training of disaster countermeasures cannot be performed by use of the NW model.

The present invention has been made in view of such circumstances, and an object of the present invention is to appropriately associate actual nodes constituting an actual network with node models on a network model with physical arrangement and the like of the actual nodes appropriately reflected.

### Solution to Problem

In order to solve the above problem, a communication network model construction device according to the present invention includes: a communication network (NW) model corresponding to a communication NW configured by NW connection of a plurality of separated data centers in which a plurality of nodes as communication devices is connected by a NW and deployed, and having a plurality of node models corresponding to the plurality of nodes connected to the communication NW; a specification unit that specifies the data centers from position information by a global positioning system (GPS) of each of the data centers, and specifies physical information, which is information indicating addition or deletion of each of the nodes in the data centers, by any one of image information on addition or deletion of each of the nodes by a camera of each of the specified data centers and detection information on addition or deletion of each of the nodes by a sensor; an extraction unit that extracts logical information based on any one of setting information, log information, and statistical information that enable determination of addition or deletion of each of the nodes in the specified data centers and a peripheral node connected to each of the nodes; an estimation unit that estimates addition or deletion of each of the nodes by combining both the physical information and the logical information; and a setting input unit that reflects the estimated addition or deletion of each of the nodes in the data centers and a change in setting information of another node accompanying the addition or deletion of each of the nodes in the node models of the communication NW model.

### Advantageous Effects of Invention

According to the present invention, it is possible to appropriately associate actual nodes constituting an actual network with node models on a network model.

### BRIEF DESCRIPTION OF DRAWINGS

FIG. 1 is a block diagram illustrating a configuration of a communication network model construction device according to an embodiment of the present invention.

FIG. 2 is a first flowchart for describing the operation of the communication network model construction device according to the present embodiment.

FIG. 3 is a second flowchart for describing the operation of the communication network model construction device according to the present embodiment.

### DESCRIPTION OF EMBODIMENTS

Hereinafter, an embodiment of the present invention will be described with reference to the drawings.

### Configuration of Embodiment

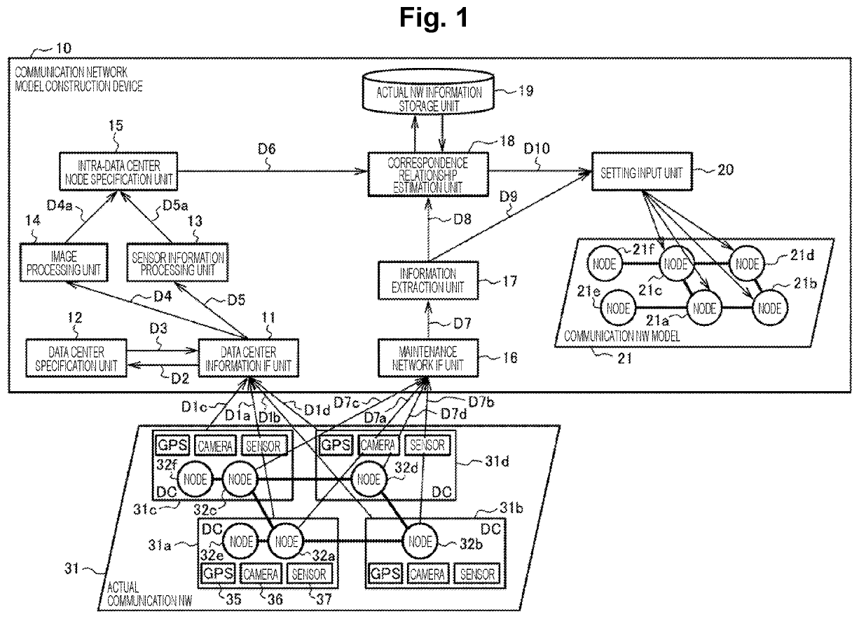

FIG. 1 is a block diagram illustrating a configuration of a communication network model construction device according to the embodiment of the present invention.

When addition or deletion of a node (actual node) connected to an actual communication network (actual NW) occurs, a communication network model construction device (also referred to as the construction device) 10 illustrated in FIG. 1 performs processing of reflecting information such as addition or deletion of the actual node and physical arrangement of the actual node in a data center in a node model of a communication NW model (NW model) and appropriately associating the NW model with the actual NW.

The construction device 10 includes a data center information interface (IF) unit 11, a data center specification unit 12, a sensor information processing unit 13, an image processing unit 14, an intra-data center node specification unit 15 (node specification unit 15), a maintenance network IF unit 16, an information extraction unit 17, a correspondence relationship estimation unit 18, an actual NW information storage unit 19, a setting input unit 20, and a communication NW model 21 (NW model 21).

The data center information IF unit 11 is also referred to as the IF unit 11, and the maintenance network IF unit 16 is also referred to as the IF unit 16.

Note that the data center information IF unit 11, the data center specification unit 12, the sensor information processing unit 13, the image processing unit 14, and the intra-data center node specification unit 15 constitute a specification unit described in the claims. The maintenance network IF unit 16 and the information extraction unit 17 constitute an extraction unit described in the claims. The correspondence relationship estimation unit 18 constitutes an estimation unit described in the claims.

The NW model 21 includes a plurality of node models 21a, 21b, 21c, and 21d virtually connected by a NW, and is constructed on a NW simulator by node models 21e and 21f being connected to the node models 21a and 21c. In addition, an actual NW 31 is connected to the IF units 11 and 16. However, the node models 21a to 21d correspond to actual nodes 32a to 32d to be described later, and the node models 21e and 21f correspond to actual nodes (peripheral nodes) 32e and 32f to be described later.

The actual NW 31 includes a plurality of data centers (DCs) 31a, 31b, 31c, and 31d. The DCs 31a to 31d are constructed in distant places such as Tokyo and Osaka, or in positions separated at a shorter distance than these areas. The DCs 31a to 31d include the plurality of actual nodes 32a to 32f, global positioning systems (GPSs) 35, cameras 36, and sensors 37. FIG. 1 illustrates an aspect in which one GPS 35, one camera 36, and one sensor 37 are deployed for each of the DCs 31a to 31d. However, a plurality of GPSs 35, cameras 36, and sensors 37 may be deployed for each floor, rack, or the like of the DCs 31a to 31d.

Each of the GPSs 35 is a device for acquiring position information of a DC (for example, the DC 31a) in which the GPS 35 is deployed.

Each of the cameras 36 is a device for acquiring image information that makes it possible to recognize addition or deletion, an operation situation, and an arrangement state of the nodes 32a and 32b in a DC (for example, the DC 31a) in which the camera 36 is deployed. The image information indicates, for example, images of front surfaces, back surfaces, side surfaces, and the like of the racks that are arranged in the DCs 31a to 31d and on which objects are placed and accommodated, and images of the arrangement of various devices in rooms, and the like.

Each of the sensors 37 is radio frequency identification (RFID), a Bluetooth low energy (BLE: “Bluetooth is a registered trademark”) beacon, an infrared sensor, or the like. For example, in the case of the RFID, an RF tag is attached to an object to be detected, so that it is possible to detect an arrangement state or the like of the object to be detected. For example, in the case of the infrared sensor, it is possible to detect entry and exit of an object to be detected into and from a rack. Each of the sensors 37 as described above can acquire detection information that makes it possible to recognize the name of a node, addition or deletion of a node, and the like in a DC (for example, the DC 31a) in which the sensor 37 is deployed.

The actual nodes 32a to 32f are communication devices such as a server, a router, and a switch. In this example, it is assumed that the actual nodes 32a and 32e connected by a NW are deployed in the DC 31a, the actual node 32b is deployed in the DC 31b, the actual nodes 32c and 32f connected by a NW are deployed in the DC 31c, and the actual node 32d is deployed in the DC 31d.

The data center information IF unit 11 acquires pieces of information (referred to as device information) D1a, D1b, D1c, and D1d by the GPSs 35, the cameras 36, and the sensors 37 in the DCs 31a to 31d. The IF unit 11 notifies the data center specification unit 12 of position information D2 in the acquired pieces of device information D1a to D1d. The IF unit 11 acquires specification information D3 such as the names of the DCs 31a to 31d specified by the data center specification unit 12 by the notification.

In the data center specification unit 12 (specification unit 12), position information indicating that the DCs 31a to 31d are arranged in certain places such as Tokyo and Osaka, and specification information for specifying each of the DCs 31a to 31d are associated with each other. The specification unit 12 returns, to the IF unit 11, the specification information D3 corresponding to the position information D2 for each of the DCs 31a to 31d, of which the IF unit 11 has notified the specification unit 12.

The IF unit 11 associates the specification information D3 for each of the DCs 31a to 31d acquired from the specification unit 12 with image information D4 of the cameras 36 of the same DCs 31a to 31d, outputs the image information D4 to the image processing unit 14, associates the specification information D3 with detection information D5 of the sensors 37, and outputs the detection information D5 to the sensor information processing unit 13.

The image processing unit 14 specifies a position in the DCs 31a to 31d shown by an image of the image information D4. For example, the image processing unit 14 specifies an imaging position of the image information D4 from a floor map for each of the DCs 31a to 31d stored in a storage unit (not illustrated) in advance. Furthermore, the current image information D4 is compared with past image information D4, whereby processing of detecting addition or deletion of a node in the image and giving metadata related to the addition or deletion of the node to the image information D4 is performed. Image information D4a in the DCs 31a to 31d processed in this manner is output to the node specification unit 15 in association with the position information and the specification information of the same DCs 31a to 31d.

The sensor information processing unit 13 receives the detection information D5 of the sensors 37 associated with the specification information for each of the DCs 31a to 31d from the IF unit 11, and outputs detection information D5a indicating the names of the nodes associated with the specification information for each of the DCs 31a to 31d and addition or deletion of a node to the node specification unit 15.

The node specification unit 15 outputs physical information D6 to be described later to the correspondence relationship estimation unit 18 in accordance with the image information D4a in the DCs 31a to 31d including the position information and the specification information for each of the DCs 31a to 31d from the image processing unit 14 and the detection information D5a indicating the names of the nodes associated with the specification information for each of the DCs 31a to 31d and the addition or deletion of the node from the sensor information processing unit 13.

The physical information D6 is physical information such as the arrangement of the racks and the nodes in the DCs 31a to 31d. The physical information D6 is node specification information and appearance information indicating that a node (for example, the node 32a) is added (or deployed) or deleted (removed) to or from a first rack (not illustrated) in a DC (for example, the DC 31a).

The maintenance network IF unit 16 acquires and aggregates various types of information D7a, D7b, D7c, and D7d to be described later, which can be acquired from the actual nodes 32a to 32f, and outputs aggregated information D7 to the information extraction unit 17. The various types of information D7a to D7d are setting information, log information, and statistical information such as the number of packet arrivals.

The setting information is information for operating the actual nodes by NW connection, such as the IP address of each of the nodes, routing information, packet filter information, and QoS setting. Furthermore, the various types of information D7a to D7d include the host name, address, model, operating system (OS), and specifications related to each of the nodes, and further include logs of the peripheral nodes 32e and 32f connected to the present nodes (for example, the nodes 32a and 32c).

The information extraction unit 17 extracts the setting information such as the IP address for each of the actual nodes 32a to 32d related to the aggregated information D7 and logical information (referred to as logical information D8) related to addition/deletion of the peripheral nodes 32e and 32f, and outputs the extracted information to the correspondence relationship estimation unit 18. However, the logical information D8 includes node information such as the host name, address, model, OS, and specifications related to each of the actual nodes 32a to 32d, and node addition/deletion information detected from the logs or the like of the peripheral nodes 32e and 32f. Furthermore, the information extraction unit 17 outputs the above-described setting information (referred to as setting information D9) of the actual nodes 32a to 32f to the setting input unit 20.

The actual NW information storage unit (also referred to as the storage unit) 19 stores the physical information D6 and the logical information D8 of the actual nodes 32a to 32f, and the stored information is updated by addition or deletion by an access from the estimation unit 18.

The correspondence relationship estimation unit (also referred to as the estimation unit) 18 combines the physical information D6 from the node specification unit 15 and the logical information D8 from the information extraction unit 17 to improve the estimation accuracy of a correspondence relationship between both the actual nodes 32a to 32f and the node models 21a to 21f. Estimation information D10 of the correspondence relationship between the actual nodes and the node models with the improved estimation accuracy is output to the setting input unit 20.

More specifically, the estimation unit 18 detects an event of addition or deletion of the actual nodes 32a to 32f by the physical information D6, and specifies the actual nodes 32a to 32f from the floors, racks, and the like in the DCs 31a to 31d. Furthermore, the estimation unit 18 detects addition or deletion of the actual nodes 32a and 32f from information on the peripheral nodes 32e and 32f by use of the logical information D8, and acquires the model, specifications, address, and the like of each of the added or deleted nodes. Combining (or adding) the physical information D6 and the logical information D8 makes it possible to improve the detection and specification accuracy. Note that addition or deletion of the actual nodes 32a to 32f can be detected and specified (or estimated) by the physical information D6 or the logical information D8 alone.

A correspondence relationship between the physical information D6 and the logical information D8 will be described. For example, it is assumed that the logical information D8 is node information (logical information) such as the host name, address, model, OS, and specifications related to the actual node 32a. In addition, even from the adjacent node 32e adjacent to the actual node 32a in the NW, the addition of the actual node 32a can be detected even from the logical information D8 by use of information such as routing information of the adjacent node 32e. Here, it is assumed that the physical information D6 is node specification information and appearance information including image information (physical information) indicating that the actual node 32a is added to a rack in the DC 31a. In this case, the physical information of the actual node 32a as the physical information D6 and the logical information of the actual node 32a as the logical information D8 are in a corresponding relationship, and thus it is possible to estimate the addition of the actual node 32a and output the estimation information D10 to the setting input unit 20.

The estimation unit 18 estimates “addition” or “deletion” of a node by combining the physical information D6 and the logical information D8 related to addition or deletion of each of the actual nodes 32a to 32f in the DCs 31a to 31d. The estimation unit 18 outputs the estimation information D10 of the “addition” or “deletion” to the setting input unit 20.

In addition, the estimation unit 18 accesses the storage unit 19 and updates the stored physical information D6 and logical information D8 of the actual nodes 32a to 32f by addition or deletion of each of the actual nodes 32a to 32f in the DCs 31a to 31d on the basis of the estimation information D10.

The setting input unit 20 reflects the information on the node addition or deletion related to an actual node (for example, the node 32a) in the corresponding node model 21a in accordance with the setting information D9 from the information extraction unit 17 and the estimation information D10 from the estimation unit 18. At the same time, if the addition or deletion of the actual node causes setting information of other actual nodes to be changed, the setting information D9 related to the actual nodes in which the setting is changed is reflected in the corresponding node models. In this manner, reflecting the information on the node addition or deletion for each of the actual nodes 32a to 32f in each of the node models 21a to 21f makes it possible to obtain a correspondence relationship between the actual NW 31 and the NW model 21.

### Operation of Embodiment

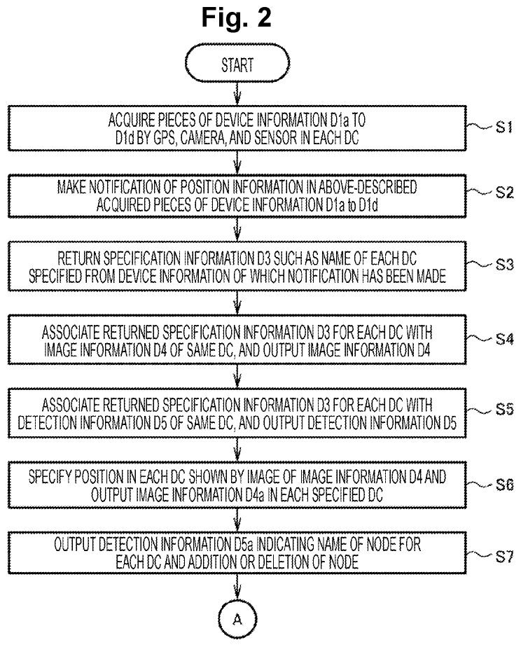

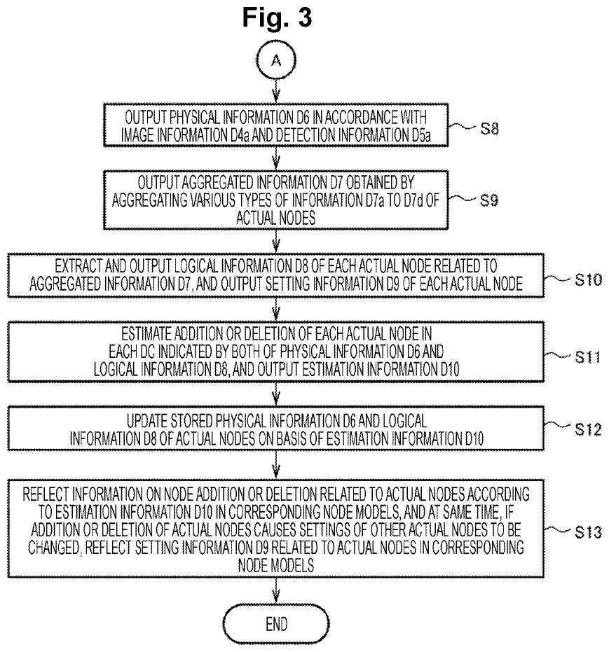

Next, the operation of the communication network model construction device according to the present embodiment will be described with reference to flowcharts illustrated in FIGS. 2 and 3.

However, it is assumed that the communication NW 31 illustrated in FIG. 1 is constructed by NW connection of the DCs 31a to 31d separated from each other at a long distance. In addition, it is assumed that the data center specification unit 12 stores position information of the DCs 31a to 31d and specification information for specifying each of the DCs 31a to 31d in a storage unit (not illustrated) in association with each other. The actual NW information storage unit 19 stores a correspondence relationship between the actual nodes 32a to 32f and the node models 21a to 21f. For example, the actual NW information storage unit 19 stores information indicating in which rack of the DC 31a the node model 21a is physically deployed, how the node model 21a is logically set, and the like.

In step S1 illustrated in FIG. 2, the data center information IF unit 11 acquires the pieces of device information D1a to D1d by the GPSs 35, the cameras 36, and the sensors 37 in the DCs 31a to 31d.

In step S2, the IF unit 11 notifies the data center specification unit 12 of the position information D2 in the acquired pieces of device information D1a to D1d.

In step S3, the data center specification unit 12 returns, to the IF unit 11, the specification information D3 such as the names of the DCs 31a to 31d specified from the pieces of device information D1a to D1d of which the data center specification unit 12 has been notified.

In step S4, the IF unit 11 associates the specification information D3 for each of the DCs 31a to 31d acquired from the specification unit 12 with the image information D4 of the cameras 36 of the same DCs 31a to 31d, and outputs the image information D4 to the image processing unit 14.

In step S5, the IF unit 11 associates the specification information D3 for each of the DCs 31a to 31d acquired from the specification unit 12 with the detection information D5 of the sensors 37 of the same DCs 31a to 31d, and outputs the detection information D5 to the sensor information processing unit 13.

In step S6, the image processing unit 14 specifies a position in the DCs 31a to 31d shown by an image of the image information D4. The image information D4a in the specified DCs 31a to 31d is output to the node specification unit 15 in association with the position information and the specification information of the same DCs 31a to 31d.

In step S7, the sensor information processing unit 13 receives the detection information D5 of the sensors 37 associated with the specification information for each of the DCs 31a to 31d, and outputs the detection information D5a indicating the names of the nodes associated with the specification information for each of the DCs 31a to 31d and addition or deletion of a node to the node specification unit 15.

In step S8 illustrated in FIG. 3, the node specification unit 15 outputs the physical information D6 to the correspondence relationship estimation unit 18 in accordance with the image information D4a representing physical images in the DCs 31a to 31d from the image processing unit 14 and the detection information D5a indicating the names of the nodes for each of the DCs 31a to 31d and obtained by physically detecting the addition or deletion of the node from the sensor information processing unit 13. That is, the physical information D6 indicating that a node (for example, the node 32a) has been added to or deleted from a physical rack or the like in the DCs 31a to 31d is output to the correspondence relationship estimation unit 18.

In step S9, the maintenance network IF unit 16 acquires and aggregates the various types of information D7a to D7d, which are acquired from the actual nodes 32a to 32f and include setting information for operating the actual nodes, log information, and statistical information, and outputs the aggregated information D7 to the information extraction unit 17.

In step S10, the information extraction unit 17 extracts the setting information such as the IP address for each of the actual nodes 32a to 32f related to the aggregated information D7 and the logical information D8 related to addition/deletion of the peripheral nodes 32e and 32f, and outputs the extracted information to the correspondence relationship estimation unit 18. In addition, the information extraction unit 17 outputs the setting information D9 such as the IP address for each of the actual nodes 32a to 32f related to the aggregated information D7 to the setting input unit 20.

In step S11, the estimation unit 18 combines the physical information D6 from the node specification unit 15 and the logical information D8 from the information extraction unit 17 to improve the estimation accuracy of the correspondence relationship between both the actual nodes 32a to 32f and the node models 21a to 21f with the physical arrangement and the like of the actual nodes 32a to 32f appropriately reflected. The estimation information D10 of the correspondence relationship between the actual nodes and the node models with the improved estimation accuracy is output to the setting input unit 20.

In step S12, the estimation unit 18 updates the physical information D6 and the logical information D8 of the actual nodes 32a to 32f stored in the storage unit 19 by addition or deletion of each of the actual nodes 32a to 32f in the DCs 31a to 31d on the basis of the estimation information D10.

In step S13, the setting input unit 20 reflects information on the node addition or deletion related to the actual nodes 32a to 32f according to the estimation information D10 from the estimation unit 18 in the corresponding node models 21a to 21f. At the same time, if the addition or deletion of the actual nodes causes setting information of other actual nodes to be changed, the setting information D9 related to the actual nodes in which the setting is changed is reflected in the corresponding node models. With this reflection, the correspondence relationship between the actual nodes 32a to 32f and the node models 21a to 21f can be obtained, so that a correspondence relationship between the actual NW 31 and the NW model 21 can be obtained.

### Effects of Embodiment

Effects of the communication network model construction device 10 according to the embodiment of the present invention will be described.

The construction device 10 includes the communication NW model 21 corresponding to the communication NW 31 configured by NW connection of the plurality of separated DCs 31a to 31d in which the plurality of actual nodes (nodes) 32a to 32f as communication devices is connected by a NW and deployed, and having the plurality of node models 21a to 21f corresponding to the plurality of actual nodes 32a to 32f connected to the communication NW 31.

The construction device 10 further includes a specification unit constituted by the data center information IF unit 11, the data center specification unit 12, the sensor information processing unit 13, the image processing unit 14, and the intra-data center node specification unit 15. In addition, the construction device 10 further includes an extraction unit constituted by the maintenance network IF unit 16 and the information extraction unit 17, and further includes the estimation unit 18 and the setting input unit 20.

The specification unit specifies the DCs 31a to 31d from the position information by the GPS 35 of each of the DCs 31a to 31d, and obtains the physical information D6, which is information indicating addition or deletion of each of the actual nodes 32a to 32f in the DCs 31a to 31d, by any one of the image information on addition or deletion of each of the actual nodes 32a to 32f by the camera 36 of each of the specified DCs 31a to 31d and the detection information on addition or deletion of each of the actual nodes 32a to 32f by the sensor 37.

The extraction unit obtains the logical information D8 based on any one of setting information, log information, and statistical information that enable determination of addition or deletion of each of the actual nodes 32a to 32f in the specified DCs 31a to 31d and the peripheral nodes 32e and 32f connected to the actual nodes 32a and 32c.

By combining the physical information D6 and the logical information D8, the estimation unit 18 improves the estimation accuracy of the correspondence relationship between the actual nodes 32a to 32f and the node models 21a to 21f with the physical arrangement and the like of the actual nodes 32a to 32f appropriately reflected.

The setting input unit 20 is configured to perform processing of reflecting the estimated addition or deletion of each of the actual nodes 32a to 32f in the DCs 31a to 31d in the node models 21a to 21f of the communication NW model 21.

According to this configuration, addition or deletion of an actual node connected to the actual NW 31, the physical arrangement of the actual node, and the like can be reflected in the NW model 21. Therefore, it is possible to appropriately associate the actual nodes 32a to 32f with the node models 21a to 21f.

### Program

In addition, a program executed by a computer of the present embodiment will be described. It is assumed that the computer is the communication network model construction device 10 including the communication NW model 21 corresponding to the communication NW 31 configured by NW connection of the plurality of separated DCs 31a to 31d in which the plurality of actual nodes (nodes) 32a to 32f as communication devices is connected by a NW and deployed, and having the plurality of node models 21a to 21f corresponding to the plurality of actual nodes 32a to 32f connected to the communication NW 31.

The program causes the computer to function as: a means for specifying the data centers (DCs) 31a to 31d from the position information by the GPS 35 of each of the DCs 31a to 31d, and specifying the physical information D6, which is information indicating addition or deletion of each of the actual nodes 32a to 32f in the DCs 31a to 31d, by any one of the image information on addition or deletion of each of the actual nodes 32a to 32f by the camera 36 of each of the specified DCs 31a to 31d and the detection information on addition or deletion of each of the actual nodes 32a to 32f by the sensor 37; a means for extracting the logical information D8 based on any one of setting information, log information, and statistical information that enable determination of addition or deletion of each of the actual nodes 32a to 32f in the specified DCs 31a to 31d and the peripheral nodes 32e and 32f connected to the actual nodes 32a and 32c; a means for detecting addition or deletion of each of the actual nodes 32a to 32f by combining both the physical information D6 and the logical information D8; and a means for reflecting the detected addition or deletion of each of the actual nodes 32a to 32f in the DCs 31a to 31d and a change in setting information of another actual node accompanying the addition or deletion of the actual nodes in the node models 21a to 21f of the communication NW model 21.

According to the program, similarly to the effect of the communication network model construction device 10 described above, it is possible to appropriately associate the NW model 21 with the actual NW 31. However, the program is stored in a storage medium, and a central processing unit (CPU) reads and executes the program from the storage medium.

### Effects

(1) A communication network model construction device includes: a communication network (NW) model corresponding to a communication NW configured by NW connection of a plurality of separated data centers in which a plurality of nodes as communication devices is connected by a NW and deployed, and having a plurality of node models corresponding to the plurality of nodes connected to the communication NW; a specification unit that specifies the data centers from position information by a global positioning system (GPS) of each of the data centers, and specifies physical information, which is information indicating addition or deletion of each of the nodes in the data centers, by any one of image information on addition or deletion of each of the nodes by a camera of each of the specified data centers and detection information on addition or deletion of each of the nodes by a sensor; an extraction unit that extracts logical information based on any one of setting information, log information, and statistical information that enable determination of addition or deletion of each of the nodes in the specified data centers and a peripheral node connected to each of the nodes; an estimation unit that estimates addition or deletion of each of the nodes by combining both the physical information and the logical information; and a setting input unit that reflects the estimated addition or deletion of each of the nodes in the data centers and a change in setting information of another actual node accompanying addition or deletion of an actual node in the node models of the communication NW model.

According to this configuration, addition or deletion of an actual node connected to the actual communication NW (actual NW), physical arrangement, and the like can be reflected in the communication NW model (NW model). Therefore, it is possible to appropriately associate the actual nodes with the node models.

In addition, the specific configuration can be appropriately changed without departing from the gist of the present invention.

### REFERENCE SIGNS LIST

10 Communication network model construction device
11 Data center information IF unit (specification unit)
12 Data center specification unit (specification unit)
13 Sensor information processing unit (specification unit)
14 Image processing unit (specification unit)
15 Intra-data center node specification unit (specification unit)
16 Maintenance network IF unit (extraction unit)
17 Information extraction unit (extraction unit)
18 Correspondence relationship estimation unit (estimation unit)
19 Actual NW information storage unit
20 Setting input unit
21 Communication NW model
21a to 21f Node model
31 Actual communication NW
31a to 31d DC (data center)
32a to 32f Node (actual node)
35 GPS
36 Camera
37 Sensor

1. A communication network model construction device comprising a storage device storing instructions and a processor configured to execute the instructions to perform operations comprising:
implementing a communication network (NW) model corresponding to a communication NW configured by NW connection of a plurality of separated data centers in which a plurality of nodes as communication devices is connected by a NW and deployed, and having a plurality of node models corresponding to the plurality of nodes connected to the communication NW;
specifying the data centers from position information by a global positioning system (GPS) of each of the data centers, and specifying physical information, which is information indicating addition or deletion of each of the nodes in the data centers, by any one of image information on addition or deletion of each of the nodes by a camera of each of the specified data centers and detection information on addition or deletion of each of the nodes by a sensor;
extracting logical information based on any one of setting information, log information, and statistical information that enable determination of addition or deletion of each of the nodes in the specified data centers and a peripheral node connected to each of the nodes;
estimates estimating addition or deletion of each of the nodes by combining both the physical information and the logical information; and
reflecting the estimated addition or deletion of each of the nodes in the data centers and a change in setting information of another node accompanying the addition or deletion of each of the nodes in the node models of the communication NW model.

2. A communication network model construction method executed by a communication network model construction device including a communication NW model corresponding to a communication NW configured by NW connection of a plurality of separated data centers in which a plurality of nodes as communication devices is connected by a NW and deployed, and having a plurality of node models corresponding to the plurality of nodes connected to the communication NW, the communication network model construction method comprising:
a step of specifying the data centers from position information by a GPS of each of the data centers, and specifying physical information, which is information indicating addition or deletion of each of the nodes in the data centers, by any one of image information on addition or deletion of each of the nodes by a camera of each of the specified data centers and detection information on addition or deletion of each of the nodes by a sensor;
a step of extracting logical information based on any one of setting information, log information, and statistical information that enable determination of addition or deletion of each of the nodes in the specified data centers and a peripheral node connected to each of the nodes;
a step of estimating addition or deletion of each of the nodes by combining both the physical information and the logical information; and
a step of reflecting the estimated addition or deletion of each of the nodes in the data centers and a change in setting information of another node accompanying the addition or deletion of each of the nodes in the node models of the communication NW model.

3. A non-transitory computer-readable storage medium storing a program for causing a computer to perform operations comprising:
implementing a communication network (NW) model corresponding to a communication NW configured by NW connection of a plurality of separated data centers in which a plurality of nodes as communication devices is connected by a NW and deployed, and having a plurality of node models corresponding to the plurality of nodes connected to the communication NW;
specifying the data centers from position information by a global positioning system (GPS) of each of the data centers, and specifying physical information, which is information indicating addition or deletion of each of the nodes in the data centers, by any one of image information on addition or deletion of each of the nodes by a camera of each of the specified data centers and detection information on addition or deletion of each of the nodes by a sensor;
extracting logical information based on any one of setting information, log information, and statistical information that enable determination of addition or deletion of each of the nodes in the specified data centers and a peripheral node connected to each of the nodes;
estimating addition or deletion of each of the nodes by combining both the physical information and the logical information; and
reflecting the estimated addition or deletion of each of the nodes in the data centers and a change in setting information of another node accompanying the addition or deletion of each of the nodes in the node models of the communication NW model.
